(19) United States
(12) Patent Application Publication
(10) Pub. No.: US 2017/0066030 A1
(43) Pub. Date: Mar. 9, 2017

(54) HOT FORMING LINE AND METHOD FOR PRODUCING HOT FORMED SHEET METAL PRODUCTS

(71) Applicant: BENTELER AUTOMOBILTECHNIK GMBH, Paderborn (DE)

(72) Inventors: Georg Frost, Steinheim (DE); Max Niesse, Paderborn (DE); Jan Lackmann, Paderborn (DE); Stefan Konrad, Paderborn (DE); Hans-Gerd Lambers, Lingen (DE)

(73) Assignee: BENTELER AUTOMOBILTECHNIK GMBH, Paderborn (DE)

(21) Appl. No.: 14/616,340

(22) Filed: Feb. 6, 2015

(30) Foreign Application Priority Data
Feb. 7, 2014 (DE) 10 2014 101 539.8

(51) Int. Cl. B21D 37/16; C21D 1/06; C21D 9/00; B21D 43/00; H05B 3/24

(52) U.S. Cl. CPC B21D 37/16; B21D 43/00; H05B 3/24; C21D 9/0068; C21D 1/06

(57) ABSTRACT

A hot forming line for producing hot formed and press hardened sheet metal products made from metal plates includes a heating station and a forming station. The heating station has a bottom tool and an top tool between which a metal plate is received. The metal plate is heated in the heating station by indirect resistance heating. The heat is generated outside the metal plate and is transmitted by heat conduction into the metal plate itself. For this the bottom tool and/or the top tool has an electric resistance heating with at least one surface heating element. The surface heating element is a heating plate with a plate body made of an electrically conductive material, wherein the plate body is configured as heat conductor. For this the plate body is slotted and is for example provided with a slot, which extends over the thickness of the plate body.

### CROSS-REFERENCES TO RELATED APPLICATIONS

This application claims the priority of German Patent Application, Serial No. 10 2014 101 539.8, filed Feb. 7, 2014, pursuant to 35 U.S.C. 119(a)-(d), the content of which is incorporated herein by reference in its entirety as if fully set forth herein.

### BACKGROUND OF THE INVENTION

The present invention relates to a hot forming line with a heating station and a forming station for producing hot formed and in particular press hardened sheet-metal products from metal plates and a method for producing hot formed sheet metal products

The following discussion of related art is provided to assist the reader in understanding the advantages of the invention, and is not to be construed as an admission that this related art is prior art to this invention.

Press hardening is a method for producing ultra-high-strength, complex vehicle components with high manufacturing accuracy. It combines deep drawing with a heat treatment with the goal to increase the strength in one process. This manufacturing method requires a relatively high effort because in addition to the forming it includes a heating and subsequent defined cooling of the formed sheet metal products. The individual sub-processes have a significant influence on the component properties.

DE 24 52 486 A1 discloses a method for producing hardened sheet-metal sections from a metal plate in a press hardening method. Hereby a plate made of a hardenable steel is heated to a hardening temperature above the austenizing temperature Ac3 and is then formed in a pressing tool and subsequently hardened, while the sheet metal section remains clamped in the pressing tool. Because the sheet metal section is clamped in the pressing tool during the cooling performed as part of the hardening process, a product is obtained with high and good dimensional accuracy.

The heating of the metal plates in the serial production is currently performed predominantly in continuous furnaces, in particular roller hearth furnaces, by convection and heat radiation. Chamber furnaces are also used.

The furnace is heated according to an established heating method, which enables a homogenous heating independent of the geometry. The furnace systems are usually heated electrically or with gas. The temperatures required for the hot forming are in the case of steel sheets between 780° C. to about 1,000° C. In order to achieve the high hot forming temperatures in the metal plates, the residence time in the furnace system has to be configured correspondingly. In terms of the system technology this requires very high effort and a relatively large space.

Significantly faster is the inductive heating. It can be applied over an entire surface but also locally. However, the homogeneity depends on the inductor geometry and is significantly more inhomogeneous compared to heating in the furnace. The effectiveness of the inductive heating depends most of all on the distance of the inductor to the component. The greater the distance the lower the effectiveness. However, in the case of a low distance the energy loss is significantly greater due to the heat transfer to the inductor.

A hot forming line with an inductively heated heating device is disclosed in DE 10 2012 110 650 B3.

Also known are systems for conductive heating. In the technology of the direct resistance heating, the metal plate or the region to be heated represents itself a part of the electric circuit. A method and a device for conductively heating metal sheets is described in DE 10 2006 037 637 A1. There the metal sheet is heated by a gripper-heating system via which the energy is introduced, inserted into a pressing tool consisting of a bottom tool and an top tool, and is formed.

DE 102 12 819 B4 discloses methods for producing metallic components by means of electric resistance heating with subsequent hardening by fast cooling, wherein during the resistance heating regions are cooled or electrically bridged and/or thermally bridged in a targeted manner so that the temperature in these regions remains below the austenizing temperature and as a result unhardened regions remain in the sheet metal products.

DE 10 2012 110 649 B3 discloses a hot forming line for producing a hot formed and press hardened steel sheet product, in particular a motor vehicle component. The hot forming line has a temperature treatment station, wherein in the temperature treatment station locally different regions can be heated to different temperatures. The temperature treatment occurs by conductive contact, using exchangeable temperature treatment plates.

A heating device with a bottom heating unit and a top heating unit for heating a metallic plate is disclosed in EP 2 216 417 A2. Each heating unit has a heatable plate, which is comes into contact with the plate. The heating plate of the bottom and/or top heating unit has multiple heating segments which are spaced apart in a predetermined grid and which are displaceable relative to each other in a plane which is defined by a contact surface between the heating segments and the plate. The heating segments each have an integrated heating element in the form of a resistance heating.

EP 2 182 081 A1 discloses a method and a device for thermal treatment of a coated steel sheet body. Also in this case the heating occurs via surface elements in the form of contact plates.

It would therefore be desirable and advantageous to provide an improved hot forming line regarding systems technology with a rationally configured conductive heating system, that enables an efficient heating of metal plates for the hot forming in a hot forming line.

### SUMMARY OF THE INVENTION

According to one aspect of the present invention, a hot forming line includes a heating station and a forming station for producing hot formed and in particular press hardened sheet metal products from metal plates, said heating station having a bottom tool and an top tool constructed to receive there between a metal plate to be heated, said bottom tool and/or said top tool having an electric resistance heating comprising at least one surface heating element constructed as a heating plate, said heating plate comprising a plate body made from an electrically conductive material said plate body being configured as a heat conductor.

The hot forming line according to the invention for producing hot formed and press hardened sheet metal products from metal plates includes a heating station and a forming station. The heating station has a bottom tool and a top tool between which a metal plate for heating is received. The warming up or heating up of a metal plate in the heating station occurs conductively by indirect resistance heating. The heat is generated outside the metal plate and is transmitted from the surface of the metal plate into the metal plate itself. For this the bottom tool and/or the top tool has an electric resistance heating with at least one surface heating element. The heat is transmitted from the surface heating element to the metal plate by heat conduction due to the at least indirect contact between the surface heating element and the metal plate to be heated.

According to the invention, the surface heating element is a heating plate with a plate body made of an electrically conductive material, wherein the plate body is configured as heating conductor. The plate body itself directly forms the thermal conductor. The heating conductor defines an electric path in the plate body. In the heating conductor electric energy is transformed into heat.

For heating a metal plate, the metal plate is received between the upper and the bottom tool. For this purpose, a corresponding receiving space is provided between the bottom tool and the top tool. The surface element or elements or heating plates can come into direct contact with a metal plate. When in this case the heating surface of the heating plate and the metal plate directly contact each other, the heating plate is switched currentless in this operating state. Another aspect of the invention provides that the heating plate indirectly contacts the metal plate. The heating surface of a heating plate can be provided with an electrical insulation or an insulating layer.

The heating conductor is preferably configured so that it releases the application-specific amount of heat which is supplied to the metal plates by heat transmission. In an advantageous embodiment of the invention a heating conductor is formed in the plate body by at least one slot, which extends over the thickness of the plate body. In a further advantageous embodiment, the heating conductor is formed by at least one horizontal slot in the plate body. Preferably the horizontal slot extends over almost the entire length or width of the plate body. The electric conduction or the electric path is established via the region of the plate body, which is not separated by the slot.

The configuration of the heating conductors occurs through the manner the slot extends in the plate body. In particular the heating conductor is multiply wound. The heating conductor may for example extend meander shaped or spiral shaped. The heating conductor has a length, which is longer than the shortest distance between the electric contacts of the heating conductor. Also more than one heating conductor can be arranged or formed in a heating plate in a circuit arrangement corresponding to the desired application.

In another aspect of the invention the plate body includes at least two plate body layers. The plate body layers are arranged atop each other in the manner of a sandwich construction. Hereby the plate body layers are insulated against each other by means of an electric insulation. Via a contact section the plate body players are electrically connected with each other so that a heating conductor is formed which defines the current path. The contact section can be a separate contact component. Preferably the contact section is a direct component of the plate body layers. In the region of the contact section the plate body layers are not electrically insulated against each other so that the current flows from one plate body layer via the contact section into the next plate body layer.

The plate body is made of an electrically conductive material. The material has a high resistivity and a high thermal stability. An aspect of the invention provides that the plate body is made of a metallic thermally conductive material. As an alternative the plate body can also be made of a ceramic thermally conductive material.

A particularly advantageous thermally conducting material within the framework of the invention is the stainless austenitic steel with the material number 1.4841 (EN material short name X15CrNiSi25-21), which is normed in the standard DIN EN 10095. This steel is heat resistant and is characterized by its good strength properties also at high temperatures. The range of use is preferably between 900° C. top 1,120° C.

The metallic thermally conducting materials also include chromium nickel alloys (CrNi). These can be used up to approximately 1,200° C. further ferritic chromium iron aluminum alloys (CrFeAl) can be used for temperatures up to 1,400° C.

The ceramic thermally conducting materials include silicone carbide (SiC). This is usually used up to temperatures of 1,600° C. Further molybdenum silizide (MoSi2) is available for applications up top 1,850° C.

Within the framework of the invention also a ceramic thermally conducting material in the form of silicone-infiltrated silicone carbide (SiSiC) is considered advantageous. This is silicone carbide with metallic silicone incorporated in the lattice. This thermally conducting material can be used up to temperatures of over 1,300° C. It also has a very high pressure resistance of about 2,000 MPa also at high temperatures. In addition the thermally conducting material is characterized by its good corrosion resistance and wear resistance. Further advantageous are its high heat capacity and the low heat expansion.

Particularly advantageously the heating plate is received in an enclosure. The enclosure surrounds or encloses the outer side borders of the heating plate. The enclosure serves for thermal and electrical insulation and also for mechanical stabilization. The enclosure can for example be made of a ceramic material.

The side borders and also the backside of the heating plate are advantageously provided with a heat insulation. In addition the enclosure and/or a heat insulation can also serve for compensating thickness tolerances or tolerances with regard to the insertion position of a metal plate.

In a practically advantageous embodiment of the heating station, a load distribution plate is arranged in the bottom tool and/or in the top tool. For this the bottom tool and/or the top tool can be integrated into the tool scaffold of the heating station through integration of the load distribution plate. The load distribution plate can in particular be fixed on a press bed by spring elements.

For heating a metal plate, the heating surface of the heating plate can come into direct contact with the metal plate. For this the heating plate is heated beforehand. Prior to contact of the heating plate with the metal plate, the electric current flow of the heating plate is interrupted. In this way an electric short circuit via the metal plate is prevented. This approach is possible with a correspondingly configured cycle control.

A further aspect provides that the heating plate is provided with an electric insulation at its heating surface, which contacts the metal plate. This alternative aspect provides to avoid a direct contact between the heating plate and the metal plate. The electric insulation can be realized by a coating of the heating surface of the heating plate or a separate insulating layer or insulating plate. This allows retaining the electric current flow also during the holding closed time or holding closed phase and with this during the heating of a metal plate. This is more advantageous because it avoids constantly changing switching cycles of the electric system.

Advantageously the resistance heating has a number of selectively controllable surface heating elements, which can be switched on or off. This makes it possible to heat certain regions of the metal plate differently or to not heat certain regions of the metal plate. The surface heating elements can also be heated differently via a controllable voltage or current supply, in order to enable a regionally different heating of a metal plate. It can also be selected between controlling individual surface heating elements or surface heating elements interconnected as respective groups. The control also includes a selective switching on and/or off of heating surface elements. Also multiple different components or metal plates can be heated in the same heating station by appropriate switching of the surface heating elements. This can occur individually or in groups.

According to another advantageous feature of the invention, the cross section of the heating conductor can vary over its length. In particular a width of the heating conductor varies. Through corresponding configuration of the cross section of the heating conductor a temperature or heating control is also possible. Because the resistance in the heating conductor changes proportional to its cross section, the desired heat amount and the temperature can also be adjusted through the course or over via the length of the heat conductor or in sections of the heat conductor.

The hot forming line according to the invention is not only suited for heating planar metal plates. Also metal plates with varying thickness or cross sectional course, for example so-called tailored planks, can be brought to forming temperature in the heating station and subsequently hot formed and press hardened. For this, an aspect of the invention provides that between the bottom tool and the top tool a receiving space for the metal plate is provided, and the receiving space has a geometry, which is adapted to the surface contour of the metal plate.

The receiving space between the bottom tool and the top tool can also be formed by or in the plate body itself. Depending on the plate thickness different heating temperatures can be adjusted.

Thickness tolerances of the metal plates to be heated can be compensated. A tolerance compensation can for example be realized by a resilient support of the heat insulation of the bottom tool and/or top tool. A resilient support of the plate body is also conceivable. Further a tolerance compensation via an elastic deformability of the heat insulation itself is possible.

According to another advantageous feature of the invention, a further heating device can be arranged downstream or upstream of the heating station. In particular it can be provided that an addition heating device is arranged upstream of the heating station. This configuration of the hot forming line provides for a two-stage heating of a metal plate in which the metal plate is first pre heated in a first stage to a defined temperature. Subsequently the pre heated metal plate is transferred into the heating station which it is heated or heated up to forming temperature.

According to a further advantageous embodiment of the hot forming line according to the invention the heating station and the forming station are arranged within a synchronous drive unit. Between the heating station and the forming station appropriate transfer systems are integrated. The movement of the bottom tool and the top tool for the heating station and the bottom tool and the top tool of the forming station occurs synchronously preferably within a common synchronous drive unit with the same cycle.

As mentioned, appropriate plate transfer systems are provided within the synchronous drive unit between heating station and forming station. Of course transfer devices or systems are also provided for the supply of the metal plate within the hot forming line to the heating station. The same is true for the retrieval of the hot formed sheet metal products from the forming station and/or an optionally downstream arranged additional cooling station.

Generally the forming and press hardening can be conducted in one tool. However, a two-stage cooling or a two-stage hardening process is also possible. For this the heated metal plate is formed in the forming station and already cooled in the, in particular actively, cooled forming station. The adjustment of the end temperature and/or the holding of the formed sheet metal product can be realized in a second cooling stage. For this a separate cooling station is arranged downstream of the forming station.

The movement and the cycle control can further be improved in that the heating station and/or the forming station and/or the cooling station of the hot forming line are supported in a machine frame. Hereby it is strictly required that one station or all stations are supported spring elastically within the machine frame. The resilient support of the station or of movable tools of the stations prolongs the close holding time or heating up time during the heating up of the metal plate and/or the forming and or cooling time in the forming stage and/or in the cooling stage. In particular this results in a contact time between the top tool and the bottom tool, which is increased relative to the cycle time.

The hot forming line according to the invention is characterized by a rationally configured conductive heating system which enables an efficient heating of metal plates for the hot forming, in particular also a press hardening within the hot forming line.

A method for producing hot formed and in particular press hardened sheet metal products in a hot forming line according to the invention provides that a heating plate of the heating station is heated at least in regions to a plate temperature between 1,050° C. and 1,350° C. The heating plate has a higher temperature relative to the target temperature to which the metal plate is to be heated. In the heating station then an at least partial heating of the metal plate from its starting temperature to the target temperature occurs by contact of the metal plate with the heating plate. The target temperature is preferably between 850° C. and 970° C. The heating of the metal plate is performed within a time of 10 seconds or less. In particular the heating occurs within a time period of 3 and 6 seconds.

An aspect of the invention provides that the higher temperature of the heating plate is between 20% and 30% above the target temperature of the metal plates, to which the metal plates are to be heated in the heating station.

In an advantageous embodiment of the method, the transfer of the heated metal plates from the heating station to the forming station occurs within a time period of maximally 3 seconds. Heat losses can be minimized as a result of the short transfer time.

Also the transfer of the formed metal plates or the sheet metal products from the forming station into the cooling station is preformed within a time period of maximally 3 seconds. This avoids heat losses and also prevents or minimizes a distortion of the formed sheet metal product.

The hot forming line according to the invention and the method are particularly advantageous for the production of hot formed and press hardened sheet metal products from metal plates. The formed sheet metal product is at least partially hardened, in particular press hardened while it is clamped in the forming tool. Hereby the sheet metal product is cooled at least in regions to a temperature of lower than or equal to (≦) 250° C. within a time of less than or equal to (≦) 10 seconds, in particular within a time of less than or equal to (≦) 3 and 6 seconds. A cooling station can be arranged downstream of the forming station. The cooling and hardening can then exclusively be carried out in the cooling station. It is also possible to cool the hot formed sheet metal product in the forming station as wells as in a downstream cooling station. In a downstream cooling station a further cooling then takes place or a holding of the sheet metal product at the cooling temperature. The cooing can for example occur in a dip bath. As an alternative a cooling can also occur in a press hardening tool or in a contact cooling station. The latter is in particular made of lightweight metal with a high thermal conductivity and has cooling channels for conducting a cooling medium.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a principle embodiment of a heating plate in a top view and in a longitudinal section and in a cross section;

FIG. 2 shows a heating plate with outer enclosure in a top view and in a longitudinal view and in a cross section;

FIGS. 3 to 7 show different embodiments of heating stations, respectively in a view from above onto the heating plate arrangement and a cross sectional view onto the heating station;

FIG. 8 shows a section of a hot forming line according to the invention;

FIG. 9 shows a further section from another embodiment of a hot forming line;

FIG. 10 shows a heating station a forming station and a cooling station within a synchronous driving unit with a view from three different operating positions;

FIG. 11 shows a further embodiment of a heating plate in a top-view and two side views;

FIG. 12 shows a further embodiment of a heating plate with a view of a course of a heating conductor;

FIGS. 13 to 16 respectively show variants of a heating station with a representation of a heating plate or heating plates in a top view and in a side view onto the heating station;

FIG. 17 shows a technically simplified representation of a heating plate arrangement in a heating station, wherein respectively a heating plate of the bottom tool and a heating plate of the top tool are shown; and

FIG. 18 shows a schematic side view of a further embodiment of a heating plate.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

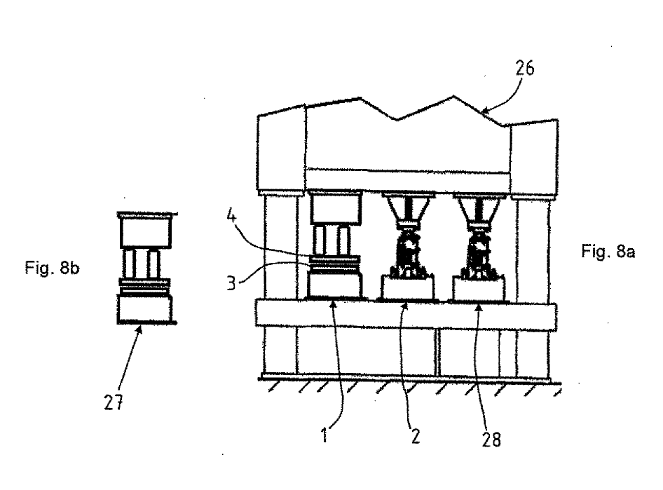

A hot forming line for producing hot formed and press hardened sheet metal products from metal plates includes a heating station 1 form heating the metal plates and a forming station 2 for forming the metal plates in the heated state. In the figures the heating station is designated with 1 and the forming station with 2. A forming station 2 is shown in FIGS. 8, 9 and 10.

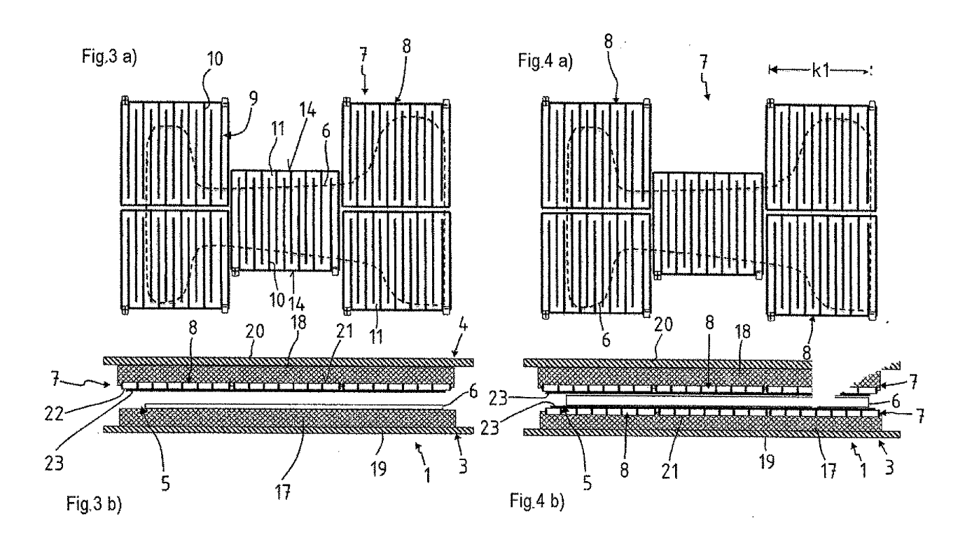

The principle construction of a heating station 1 is described with reference to FIG. 3. In FIGS. 4 to 9 and 15 to 18, corresponding components or structural parts are provided with the same reference numerals.

The heating station 1 has a bottom tool 3 and an top tool 4. Between the bottom tool and the top tool 4 a receiving space 5 is provided between which a metal plate 6 for heating is received. The power tool 3 and the top tool 4 can be opened and closed by drive means. Hereby the bottom tool 3 and the top tool 4 are moved toward each other or away from each other. During the heating of a metal plate 6 the bottom tool 3 and the top tool 4 come into direct contact with the surface of the metal plate 6.

The bottom tool 3 and/or the top tool 4 have an electric resistance heating 7 with at least one heating element. The surface heating element is a heating plate 8. The heating plate 8 has a plate body 9 made of an electrically conducting material. In the plate body 9 a heat conductor 11 is formed by at least one slot 10 or the plate body 9 itself forms the heat conductor 11 in material unity. The heat conductor 11 defines the current path between the electric contacts 12, 13 of the heating plate 8. In the figures the positive contact 12 (plus pole) is indicated with the sign “+” and the negative contact 13 (minus pole) with the sign “−”. The slot 10 extends over the entire thickness d of the plate body 9. The width of a slot 10 is dimensioned so that insulation is ensured between the heat conductor sections which extend parallel to each other and no current flashover occurs. In principle the slot 10 can be filled by an electrically insulating material.

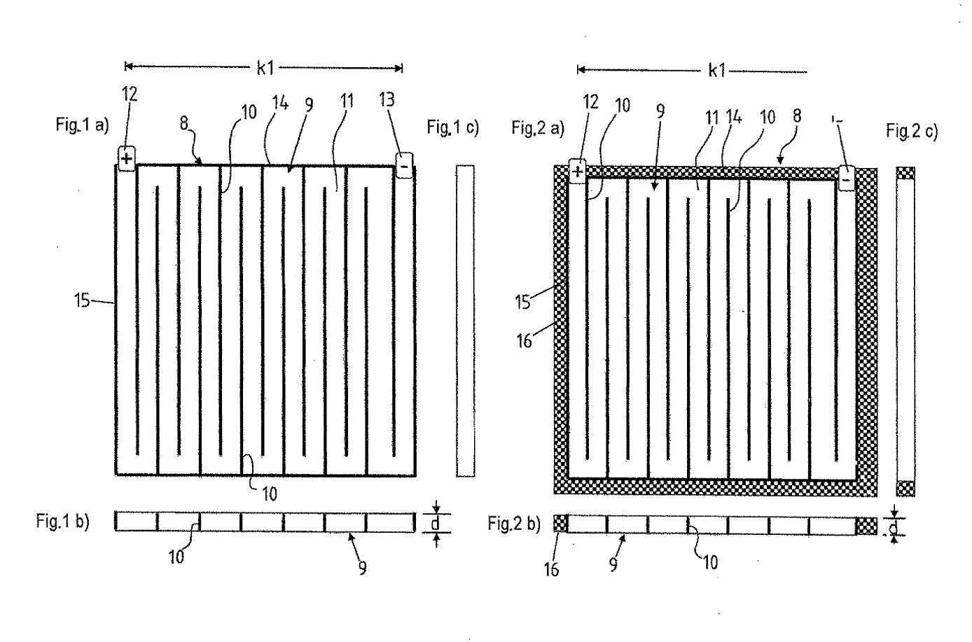

As can be in particular recognized in FIGS. 1 and 2 and 11 and 12, the heat conductor 11 is multiply wound. In the configuration of the heating plate 8 according to the FIGS. 1 and 2, the heating conductor 11 extends meander shaped. The heating conductor 11 is hereby realized by multiple individual slots 10 in the plate body 9 which are arranged parallel to each other. The individual slots 10 are respectively guided into the plate body from opposing side borders. The individual slots 10 then end respectively at a distance before the opposing side border.

The plate body 9 of the heating plate 8 can be made of a metallic thermally conducting material, in particular a non-corrosive, heat resistant austenitic chromium nickel steel 1.4841. The plate body 9 can also be made of a ceramic heat thermally conducting material, in particular form silicone carbide (SiC) or from silicone-infiltrated silicone carbide (SiSiC).

The length of the heat conductor 11 is respectively greater or longer than the shortest distance k1, k2 between the electric contacts 12, 13 of the heat conductor 1.

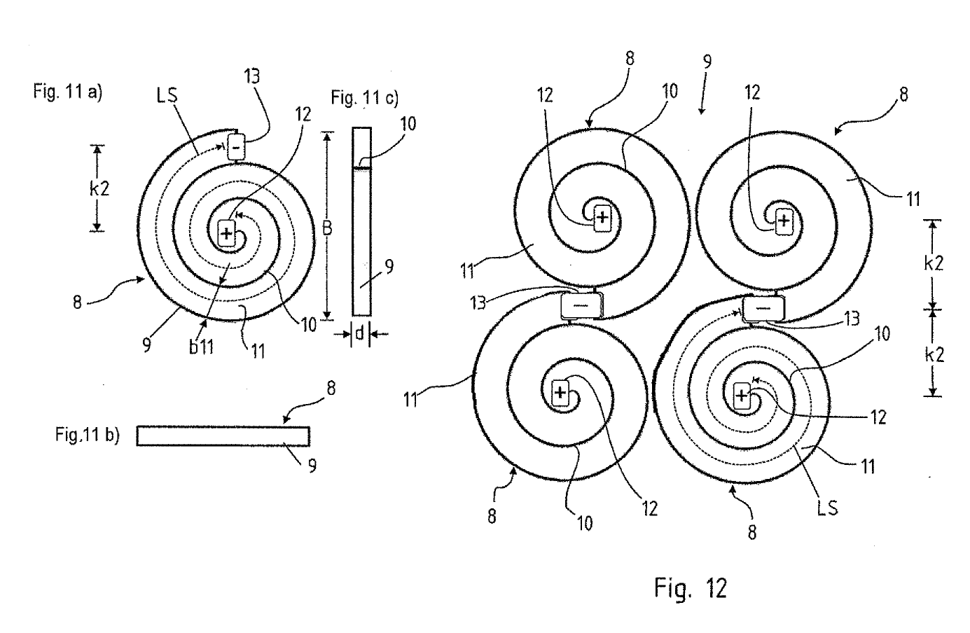

In the embodiment of a heating plate 8 as shown in FIGS. 11 and 12, the heat conductor 11 extends spiral shaped.

As shown in the view of FIG. 11a, the slot 10 extends spiral shaped, whereby the spiral shaped heat conductor 11 is formed. Due to a constant distance of the slot 10, the heat conductor 11 has a constant width b11.

It can also be seen in FIG. 11a that the averaged length LS of the heat conductor 11 is longer that the shortest distance k2 between the electric contacts 12, 13.

FIGS. 11b and 11c further show two side views of the plate body 9 according to FIG. 11a.

FIG. 11c shows that the slot 10 extends over the entire thickness d of the plate body 9.

A further embodiment is shown in FIG. 12 in which multiple spiral heating plates 8, which extend spiral shaped, are arranged adjacent each other, wherein the heat conductor 11 of each heating plate 8 is in each case formed by a slot 10.

FIG. 12 also shows that two respective heat conductors 11 are supplied with voltage or current via an electric contact 13 and two electric contacts 12. It can further be seen that the length LS of each heat conductor 11 is in each case greater or longer that the shortest distance k2 between the electric contacts 12, 13.

FIG. 2 shows the heating plate 8 with an enclosure which encases its side borders 14, 15. The enclosure 16 serves for mechanical stabilization and/or thermal insulation of the heating plate 8.

The heating station 1 shown in FIG. 3 has a bottom tool 3 and an top tool 4. In the here shown exemplary embodiment, overall five heating plates 8 are arranged in the top tool 4. The metal plate 6 to be heated is shown with dashed lines in FIG. 3a). The metal plate 6 serves for producing a hot formed and press hardened B-column for a motor vehicle.

In the bottom tool 3 and the top tool 4 a thermal insulation in the form of a lower insulating plate 17 and an upper insulating plate 18 is provided.

Further in the bottom tool 3 and also in the top tool 4 a load distribution plate 19, 20 is provided. The upper insulating plate 18 forms a heat insulation for the back side 21 and the side borders 14, 15 of the heating plate 8 or heating plates 8. As can be seen in FIG. 3b) the metal plate 6 to be heated rests on the lower insulating plate 17 of the bottom tool 3 for the heating process. The heating surface 22 of the heating plates 8 facing the metal plate 6 is separated from the metal plate 6 by an electric insulation in the form of an insulating layer 23. The electric insulation layer 23 can be configured as a coating of the heating surfaces 22 of the heating plate 8. Further the electrically insulating layer 23 can be configured as an insulating layer made of an electrically insulating material.

The arrangement of the heating plates 8 is adjusted to the outer contour or the outer surface of a metal plate 6 to be heated. The metal plates 6 can be completely heated to a predetermined temperature, for example the hardening temperature of the respective metal material, in particular to austenizing temperature Ac3. It is also possible to heat different regions of the metal plates 6 to different temperatures so that the metal plate 6 has regions or sections with different temperatures. For this the heating plates 8 or the heating surface elements can be selectively controlled, for example switched on or off, or can be heated differently.

The heating station 1 as shown in FIG. 4 has an electric resistance heating 7 in the bottom tool 3 as well as in the top tool 4, with surface heating elements in the form of heating plates 8. In order to avoid a direct contact of the metal plates 6 to be heated with the heating plates 8 eh heating surface or the heating surfaces 22 of the upper heating plates 8 as well as the heating surfaces 22 of the lower heating plates 8 are provided with an puncture proof insulting layer 23. The lower insulating plate 17 receives the heating plates 8 and forms a thermal insulation of the backsides 21 and the side borders 14, 15 of the heating plates 8. The heating station 1 in the embodiment according to FIG. 4 is due to its configuration with a dual resistance heating 7 particularly suited for the heating of thick metal plates 6.

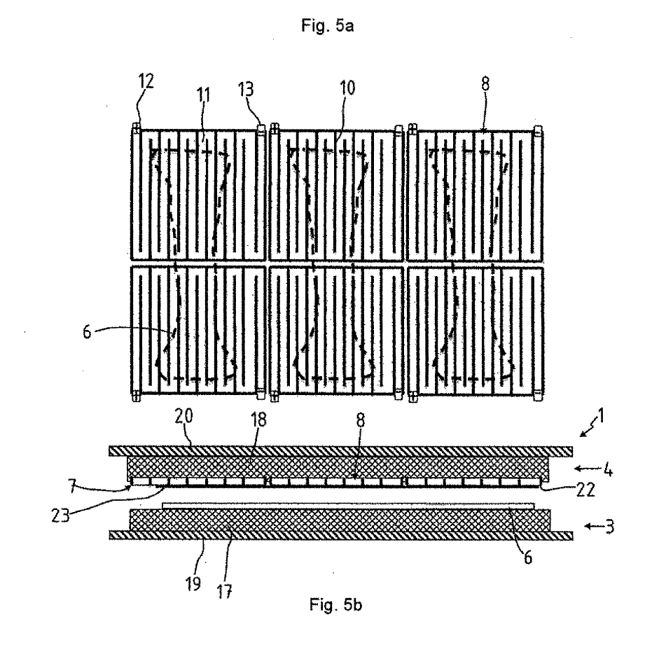

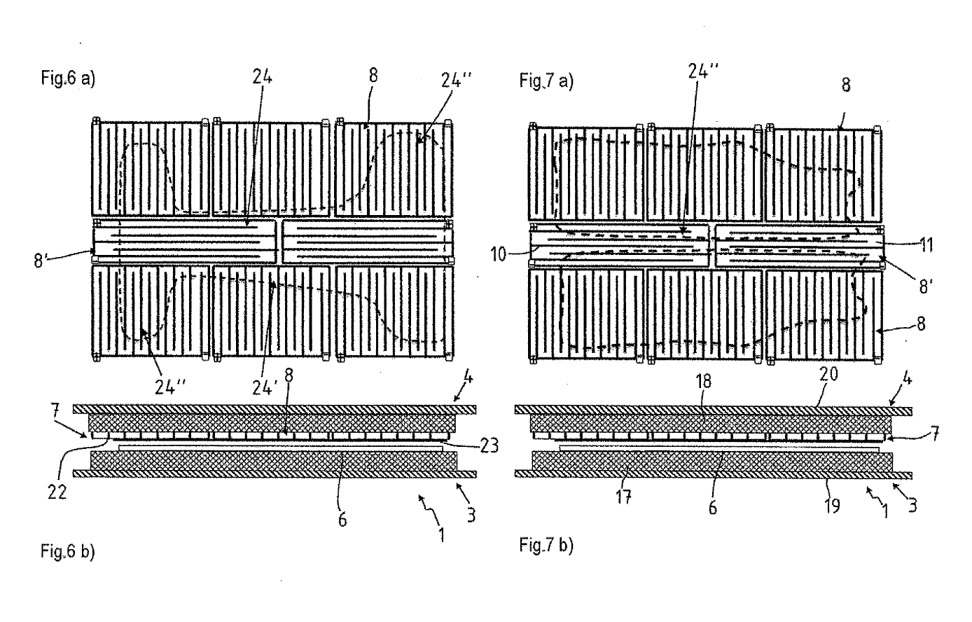

In the heating station 1 as shown in FIG. 5, three metal plates 6 are arranged parallel to each other in transverse direction. The shown metal plates 6 are used to produce door impact beams

FIGS. 6 and 7 show heat stations 1 each having eight heating plates 8 or 8′. The arrangement and heating of the heating plates 8, 8′ is selected so that sections of the metal plates 6 are heated differently. Thus regions at a border and/or central regions of the metal plate 6 can be brought to different forming temperatures. For this the heating surface elements or the heating plates 8. 8′ can be regulated or controlled. Optionally heating plates 8, 8′ can also be switched on or off. Thus for example in the embodiment according to FIG. 6, a higher temperature can be adjusted via the middle or central heating plates 8′ than in the outer heating plates 8. As a result the metal plate 6 is heated stronger in longitudinal direction in a central section 24 than in border sections 24′ of the plate and in the lower and upper wing sections 24″.

In contrast in the embodiment according to FIG. 7, two metal plates 6 are heated which serve for producing A-columns. Here, border sections 24″ are heated to a lesser degree by the central heating plates 8′.

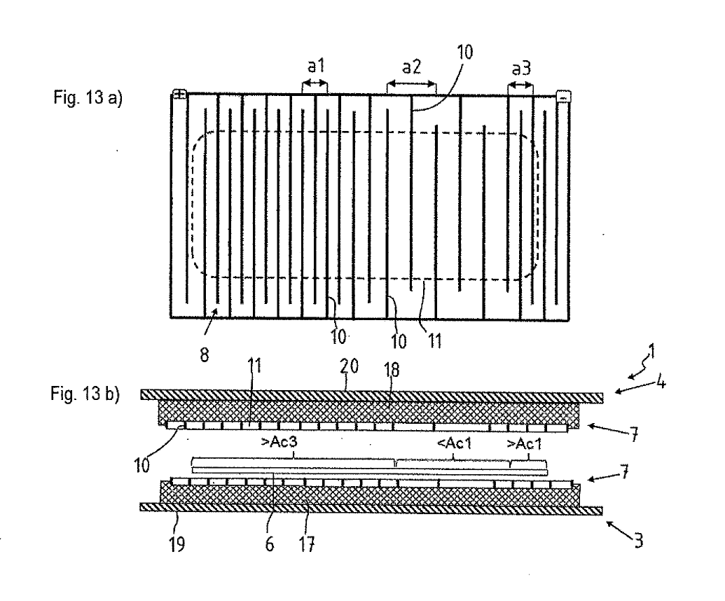

In the heating station 1 as shown in FIG. 13, the cross section of the heat conductor 11 varies over its length. This is realized via the distance a1, a2, a3 between the individual slots 10 in the plate body 9. Due to the change of the cross section of the heat conductor 1, the latter is heated to different degrees. The electric resistance changes inversely proportional with the cross section of the heat conductor 11. Consequently, heat conductor sections with greater cross sections have a lower electric resistance than heat conductor sections with a smaller cross section. The heat conductor 11 is therefore heated to a lesser degree in heat conductor sections with greater cross section than in heat conductor sections with smaller cross section; correspondingly zones or regions are formed in the heating plate 8 which are heated to different degrees. The different zones or regions are indicated in FIG. 13b) with >Ac3, <Ac1 and >Ac1. In the region >Ac3 a metal plate 6 is heated to a temperature above the austenizing temperature Ac3. For this the heating plate 8 has in this zone a higher temperature (over-temperature) relative to the target temperature of the metal plate 6. The over-temperature preferably is >1,050° C., in particular however maximally 1,350° C. In the region <Ac1 a temperature below the austenizing temperature Ac1 and in the region or zone >Ac1 a temperature above the austenizing temperature Ac1 is achieved. In the zone <Ac1, the heating plate 8 has a temperature of for example <800° C., whereas it has a temperature of >800° C. in the zone >Ac1 however preferably maximally 950° C.

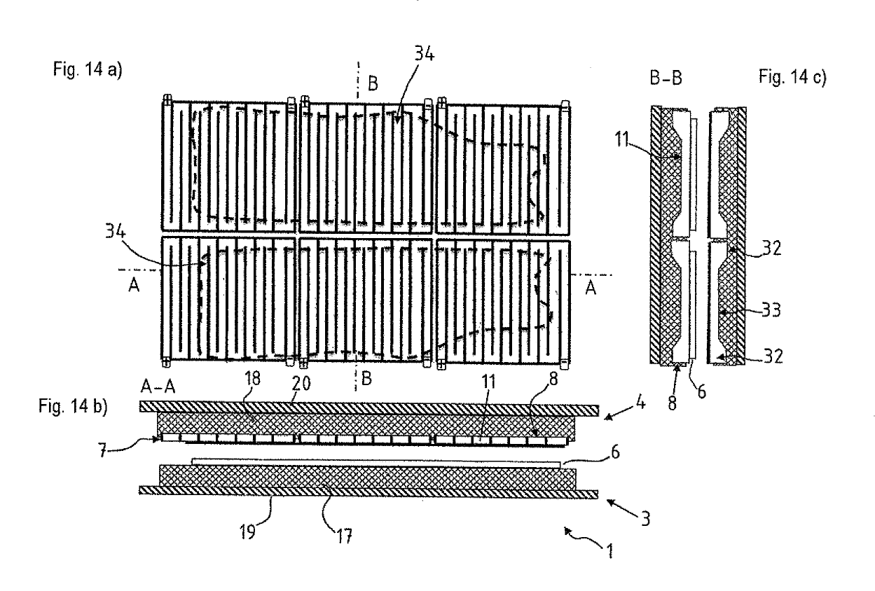

Also the heating station 1 according to the representation of FIG. 14 includes a bottom tool 3 and an top tool 4, wherein in the top tool 4 surface heating elements are provided in the form of heating plates 8. Insofar reference is made to the description above. The cross sectional view of FIG. 14c), which shows the section B-B through FIG. 14a), illustrates that the thickness of a heat conductor 11 varies. Border sections 32 of the heat conductor 11 are thicker than the central section 33 of the heat conductor 11. Because the resistance of the heat conductor 11 is greater in the central section with smaller cross section than in the border sections 32 with greater cross section, the heat conductor 11 is heated to a lesser degree in the border sections 32. Correspondingly the border regions 34 of the metal plate 6 are heated to a lesser degree by this heat conductor configuration. As a consequence no complete hardening occurs in the border regions 34 on the press hardened components made of the metal plates 6.

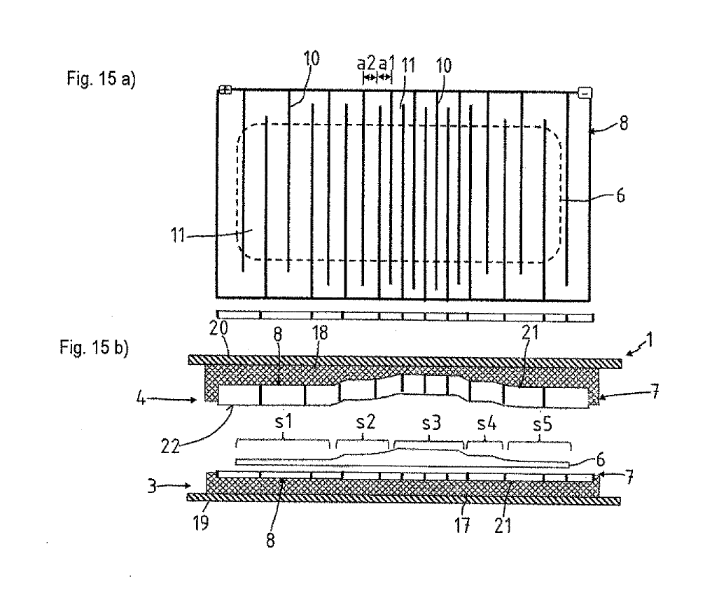

FIGS. 15a) and b) show the embodiment of a heating station 1 for heating metal plates 6 having a different cross sectional course or thickness course. The receiving space is adjusted to the surface contour of the metal plate 6 and has a geometry corresponding to the metal plate 6. This is realized by the shape of the heating plates 8 or their plate body 9 arranged in the top tool 4. The sections of the metal plate 6 that vary in their geometry are indicated by s1 to s5 in FIG. 15b). Analogously the geometry of the receiving space 45 and the heating plates 8 varies. Also in this embodiment the thickness or the cross section of the heat conductor 11 varies. Due to the small cross section of the heat conductor 11 in the section s3 the heat conductor 11 is hotter in the section s3, for example a temperature of >1,000° C. is established in the section s3. In contrast the cross section of the heat conductor 1 in the section s1 or s5 is greater with the consequence that there lower heating temperatures are prevalent for example <950° C.

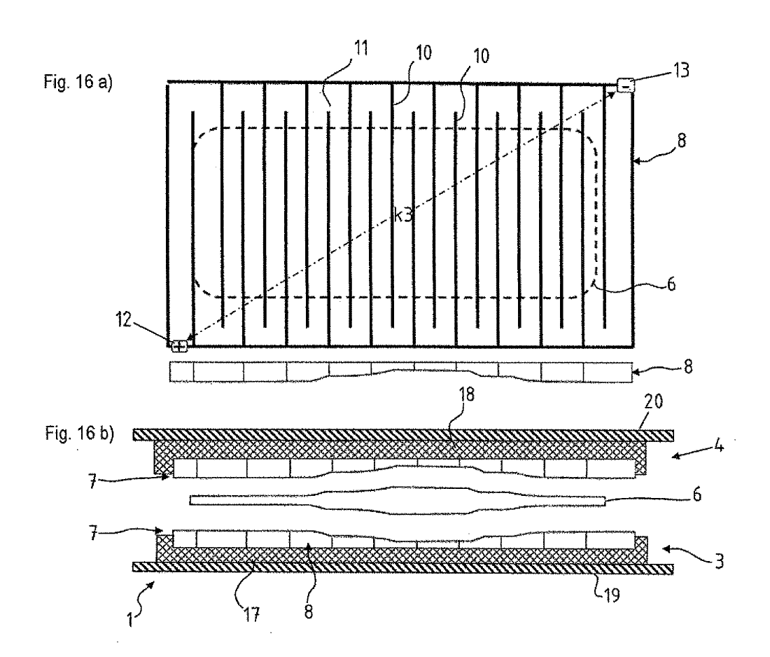

In the embodiment of a heating station 1 shown in FIG. 16, the cross sectional course of the heating plates 8 arranged in the bottom tool 3 as well as the cross sectional course of the heating plates 8 integrated in the top tool 4 varies. The receiving space between the bottom tool 3 and the top tool 4 is adjusted to the surface contour of the here shown metal plate 6 with broadside thickness gradient and has a corresponding geometry. The shortest distance between the electric contacts 12, 13 of the heat conductor 11 extends diagonally over the heating plate 8. The heat conductor 11 is multiply wound meander shaped and has a length, which is longer by multiples of the length of the shortest distance k3.

FIG. 8 shows a section of a hot forming line. Shown is a heating station 1 and a forming station 2. The heating station 1 and the forming station 2 are arranged within a synchronous drive unit 26. The synchronous drive unit 26 is a press, in particular an eccentric press. the bottom tool 3 or the top tool 4 of the heating station 1 and the forming tools of the forming station 2 are moved relative to each other in the cycle of the synchronous drive unit 26.

Outside of the synchronous drive unit 26 a heating device 27 is provided which is arranged upstream of the heating station 1. Here a homogenous pre-heating of the metal plates occurs before these are transferred into the heating station 1.

The metal plate 6 is then heated in the heating station 1 to forming temperature and subsequently transferred into the forming station 2 by a here not shown plate transfer system. In the heating station 1 the metal plate 6 can be heated homogenously, i.e., to an overall uniform forming temperature. A heating of different regions of the metal plate 6 to different temperatures is also possible as described before. In the forming station 2 the metal plate 6 is hot formed. Already in the forming station 2 the formed metal plate 6 can at least be partially cooled and hardened. Integrated in the synchronous drive unit 26 is also a cooling station 28, which is arranged downstream of the forming station. The still hot sheet metal product, which was formed in the forming station 2 from the metal plate 6, is transferred into the cooling station 28 by a here also not shown transfer system, where it is further hardened by further cooling. The cooling station 28 opens and closes in the cycle, preferably synchronous with the heating station 1 and the forming station 2.

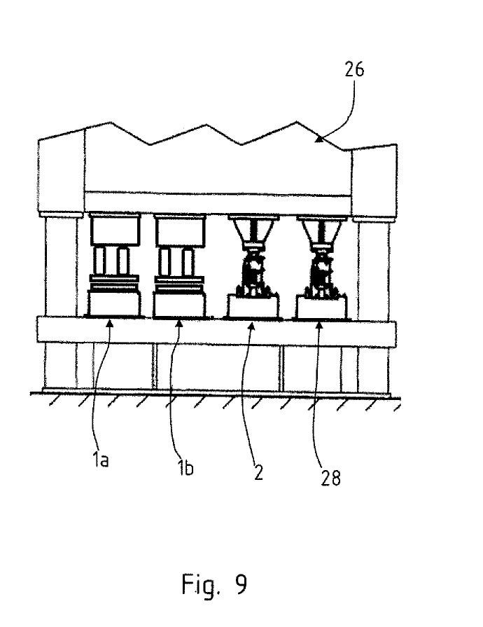

A variant of the hot forming line in which two heating stations 1a and 1b, a forming station 2 and a cooling station 28 are arranged in a synchronous drive unit 26, is shown in FIG. 9. In the heating station 1a a metal plate is heated, in particular homogenously, to a defined pre-heating temperature. The metal plate is then transferred to the heating station 1b, where defined regions of it are further heated or cooled through contact with not heated heating plates 8. Subsequently the temperature treated metal plate, i.e. the metal plate with established temperature, is transferred into the forming station 2 and formed into the sheet metal product. Already in the forming station 2 cutting operations, for example punching processes on the sheet metal product can be performed. Transfer systems then transfer the sheet metal product into the cooling station 28. Here further punching or cutting operations are then optionally performed and the sheet metal product is press hardened.

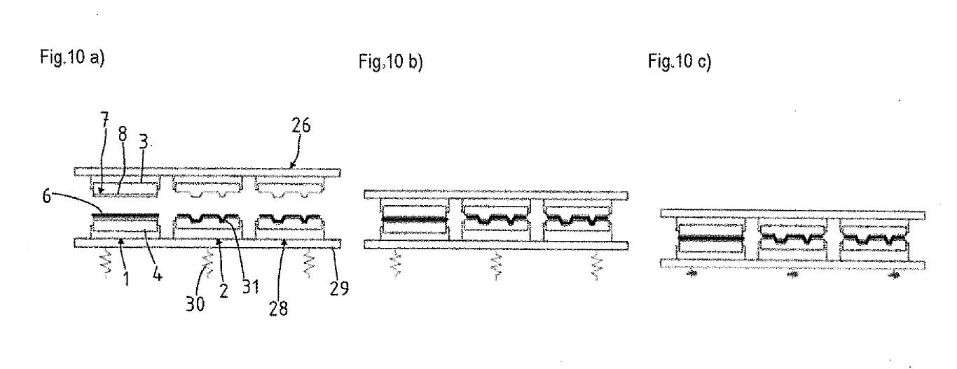

FIG. 10 shows a technically simplified representation of a heating station 1, a forming station 2 and a cooling station 28, which are together arranged in a synchronous drive unit 26. In the drive movement of the synchronous drive unit 26, the top tools and the bottom tools of the heating station 1, forming station 2 and cooling station 28 are moved relative to each other. The heating station 1 and the forming station 2 and the cooling station 28 are elastically supported on spring elements 30 in a here only schematically shown machine frame 29 of the synchronous drive unit 26. FIG. 10a) shows the synchronous drive unit 26 in opened position. Correspondingly the heating station, the forming station 2 and the cooling station 28 are also opened.

The metal plate 6 can be seen in the heating station 1. In the forming station 2 the metal plate 6 is formed into the sheet metal product 31. In the cooling station 28 the hot sheet metal product 31 is cooled from a temperature above an austenizing temperature and press hardened. FIG. 10b) shows an operating state in which the synchronous drive unit 26 is closed and the respective bottom tools and top tools come into contact with the metal plate 6 or the sheet metal product 31. In the further closing movement the machine frame 29 of the synchronous drive unit 26 is moved downward together with the heating station 1, the forming station 2 and the cooling station 298 against the force of the spring elements 30. This is shown in FIG. 10c). The movement during closing and opening of heating station 1, forming station 2 and cooling station 28 is elastically supported by the spring elements 30.

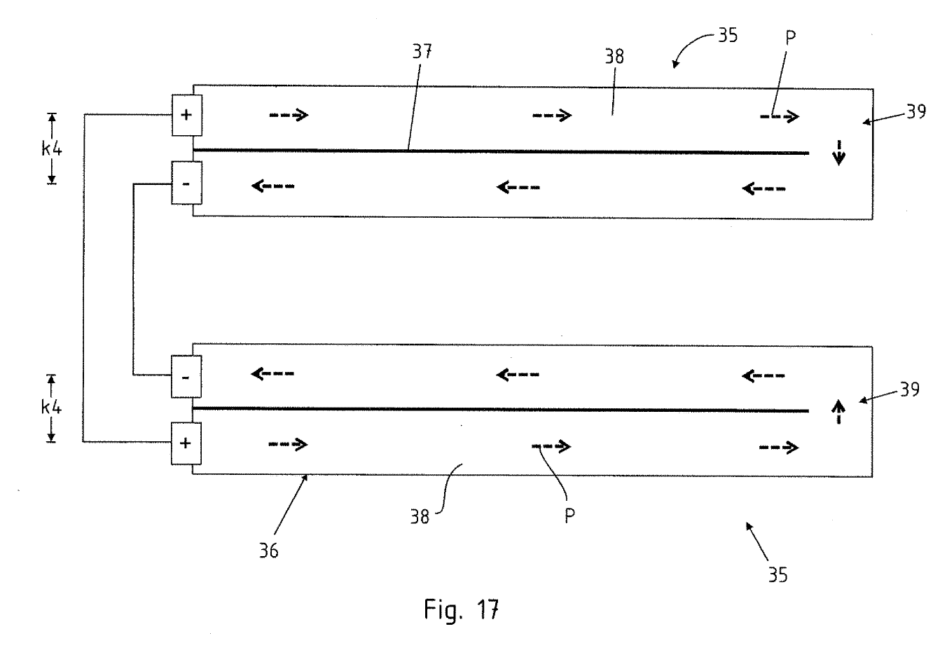

FIG. 17 schematically shows an electric resistance heating of a heating station. The resistance heating has a surface heating element in the form of an electrically conductive material in the here not shown bottom tool and also in the top tool. A heating plate 35 has a plate body 36 made of an electrically conductive material. The plate body 36 is separated along the predominant portion of its length by a horizontal slot 37. Through the horizontal slot 37 the plate body 36 is configured as heat conductor 38, which defines a current path. The current path is indicated by the arrows P. It can be seen that the slot 37 does not completely separate the plate body 36 so that on the end 39 of the plate body 36 the latter is not interrupted. The slot 37 can be filled with an electrically insulating material.

For heating the metal plate the latter is received in the heating station 1 between the heating plates. Hereby the plates come into direct contact with the heating plates 35. The heating plates 35 are connected in parallel with each other and have the same resistances. During the contact a further current flow is possible for heating the heating plates 35 and with this the metal plate. Because the opposing regions of the heating plate 35 which are connected with each other through the metal plate in the closed state, have the same electric potential at each point (voltage level) no short circuit is generated.

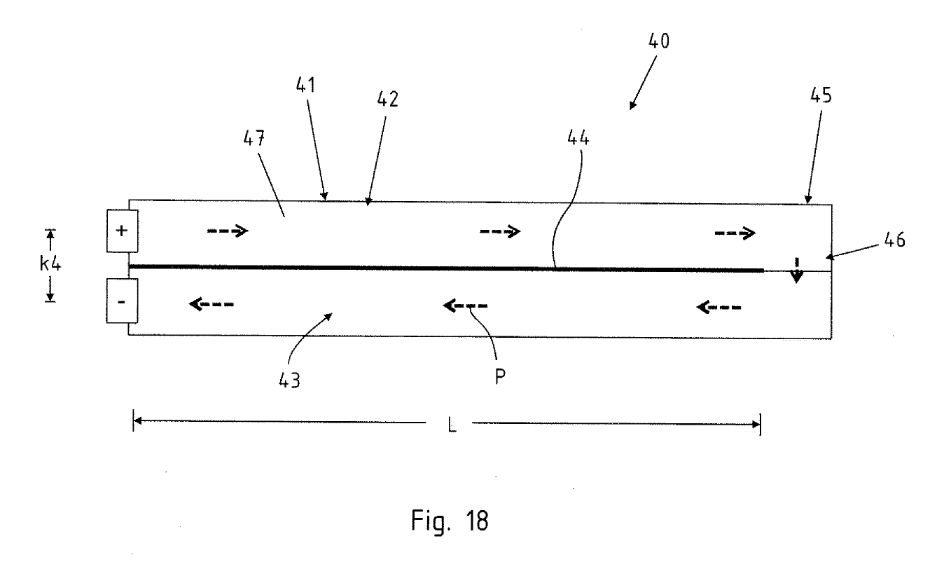

An alternative embodiment of a heating plate 40 is shown in FIG. 18. The plate body 41 of the heating plate 40 has two plate body layers 42, 43 arranged atop each other. Between the plate body layers 42, 43 an electrical insulation 44 is provided. The electrical insulation 44 extends over the predominant portion of the length L of the plate body 41 so that they are partially insulated against each other. On the end 45 of the plate body 41 a contact section 46 is formed. In the contact section 46 the plate body layers 42, 43 contact each other and are electrically conductively connected with each other. In this way a U-shaped heat conductor 47 is formed in the plate body 41. Also in this case the current path is indicated by the arrows P. in FIG. 17 and also in FIG. 18 the shortest distance between the electric contacts is indicated with k4. The heat conductor 38 as wells as the heat conductor 47 each have a length which is longer than the shortest distance k4 between the electric contacts “+” and “−”.

In a method for producing hot formed and press hardened sheet metal products made of metal plates in a hot forming line according to the invention the metal plates are heated to forming temperature in a heating station 1, subsequently removed from the heating station 1 and transferred into the forming station 2 within a time period T1 of less than 3 seconds. In the forming tool 2 the forming into the sheet metal product then occurs. In the forming station 2 itself or in a downstream cooling station 28 the hot sheet metal product is cooled with a cooling rate which is above the critical cooling rate of the metal material and in this way hardened. The cooling occurs within a time T_{K} of less than or equal to (≦) 10 seconds, in particular within a time between 3 and 6 seconds. Hereby the sheet metal product is cooled to a temperature T_{E} of less than or equal to (≦) 250° C.

The transfer of the heated metal plate from the heating station 1 into the downstream cooling station 28 occurs within a time t_{T2} of maximally 3 seconds.

An advantageous aspect of the method according to the invention provides that a heating plate 8 of the heating station 1 is at least partially heated to a plate temperature T_{P} between 1,050° C. and 1,350° C. a metal plate is then heated in the heating station 1 at least partially from a starting temperature T1 to a target temperature T2, in that the metal plate comes into contact with the heating plate 8 of the upper and/or bottom tool. The target temperature T2 is between 850° C. and 900° C. The heating of the metal plate to the target temperature T2 occurs in a time t_{E} of less than or equal to (≦) 10 seconds, in particular in a time between 4 and 6 seconds.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A hot forming line comprising:
a heating station and a forming station for producing hot formed and in particular press hardened sheet metal products from metal plates, said heating station having a bottom tool and an top tool constructed to receive there between a metal plate to be heated, said bottom tool and/or said top tool having an electric resistance heating comprising at least one surface heating element constructed as a heating plate, said heating plate comprising a plate body made from an electrically conductive material said plate body being configured as a heat conductor.

2. The hot forming line of claim 1, wherein the heat conductor has a length, which is longer than a shortest distance between electric contacts of the heat conductor.

3. The hot forming line of claim 1, wherein the heat conductor is multiply wound, in particular extends meander shaped or spiral shaped.

4. The hot forming line of claim 1, wherein the heat conductor is formed in the plate body by at least one slot which extends over a thickness of the plate body.

5. The hot forming line of claim 1, wherein the heat conductor is formed in the plate body by a horizontal slot.

6. The hot forming line of claim 1, wherein the plate body comprises at least two plate body layers arranged atop each other, said plate body layers being at least partially electrically insulated against each other and electrically conductively connected to each other via a contact section.

7. The hot forming line of claim 1, wherein the plate body is made of a metallic, thermally conductive material.

8. The hot forming line of claim 1, wherein the plate body is made of a ceramic thermally conductive material.

9. The hot forming line of claim 1, wherein the heating plate is received in a enclosure, said enclosure surrounding side borders of the heating plate.

10. The hot forming line of claim 1, wherein a heating surface of the heating plate is provided with an electrically insulating layer and wherein the heating plate contacts the metal plate via the electrically insulating layer.

11. The hot forming line of claim 1, wherein the resistance heating comprises selectively controllable surface heating elements.

12. The hot forming line of claim 1, wherein a cross section of the heating conductor varies over its length.

13. The hot forming line of claim 1, wherein a receiving space for the metal plate is provided between the bottom tool and the top tool, said receiving space having a geometry which is adjusted to a surface contour of the metal plate.

14. The hot forming line of claim 1, wherein further comprising at least one further heating station arranged upstream or downstream of the heating station.

15. The hot forming line of claim 1, wherein the heating station and the forming station are arranged within a synchronous drive unit.

16. The hot forming line of claim 15, further comprising a plate transfer system arranged within the synchronous drive unit between the heating station and the forming station.

17. The hot forming line of claim 1, further comprising a separate cooling station arranged downstream of the forming station.

18. The hot forming line of claim 17, further comprising a machine frame, said heating station and/or said forming station and/or said cooling station being spring elastically supported in the machine frame.

19. A method for producing hot formed and in particular press hardened sheet metal products in a hot forming line, comprising:
heating at least a region of a heating plate of a heating station to a plate temperature between 1,050° C. and 1,350° C., said heating station having a bottom tool and an top tool, said bottom tool and/or said top tool having an electric resistance heating comprising at least one surface heating element constructed as a heating plate, said heating plate comprising a plate body made from an electrically conductive material said plate body being configured as a heat conductor;
inserting a metal plate into the heating station between the bottom tool and the top tool; and
heating at least a region of the metal plate from a starting temperature to a target temperature by contacting the metal plate with the heating plate, wherein the target temperature is between 850° C. and 970° C. and the heating from the starting temperature to the target temperature is performed within a time of less than or equal to 10 seconds, in particular in a time between 3 and 6 seconds.

20. The method of claim 19, further comprising transferring the heated metal plate of from the heating station into a forming station within a time of maximally 3 seconds and forming the metal plate in the forming station.

21. The method of claim 20, further comprising transferring the metal plate from the forming station into a cooling station arranged downstream of the forming station within a time of maximally 3 seconds.

22. The method of claim 20, further comprising hardening at least a region of the formed sheet metal product, in particular by press hardening, wherein the at least a region of the sheet metal product is cooled in the forming station and/or a downstream cooling station to a temperature of less than or equal to 250° C. within a time of less than or equal to 10 seconds, in particular within a time between 3 and 6 seconds.
